(19) United States
(12) Patent Application Publication
(10) Pub. No.: US 2019/0279235 A1
(43) Pub. Date: Sep. 12, 2019

(54) SHARED VEHICLE MANAGEMENT SERVER AND NON-TRANSITORY STORAGE MEDIUM STORING SHARED VEHICLE MANAGEMENT PROGRAM

(71) Applicant: Toyota Jidosha Kabushiki Kaisha, Toyota-shi Aichi-ken (JP)

(72) Inventors: Daiki Kaneichi, Nisshin-shi Aichi-ken (JP); Masahiro Nakano, Nagoya-shi Aichi-ken (JP)

(73) Assignee: Toyota Jidosha Kabushiki Kaisha, Toyota-shi Aichi-ken (JP)

(21) Appl. No.: 16/295,325

(22) Filed: Mar. 7, 2019

(30) Foreign Application Priority Data
Mar. 12, 2018 (JP) 2018-044400

(51) Int. Cl. G06Q 30/02; G06N 20/00; G06Q 10/06; G06Q 10/02; G06Q 40/00

(52) U.S. Cl. CPC G06Q 30/0202; G06N 20/00; G06Q 40/12; G06Q 10/02; G06Q 10/067

(57) ABSTRACT

A shared vehicle management server includes: a use history management section configured to manage, per model of shared vehicles, as use history of at least one parking lot, a use start point where a user starts using a shared vehicle among the shared vehicles; a demand calculation section configured to calculate, based on the use history of the at least one parking lot, a demand for the shared vehicles per model of the shared vehicles in each of the at least one parking lot; and a vehicle allocation management section configured to manage allocation of the shared vehicles to each of the at least one parking lot per model of the shared vehicles, based on the demand for the shared vehicles per model of the shared vehicles, and manage, per region including the at least one parking lot, use and return of the shared vehicles.

### CROSS-REFERENCE TO RELATED APPLICATIONS

This application claims priority to Japanese Patent Application No. 2018-044400 filed on Mar. 12, 2018, which is incorporated herein by reference in its entirety including the specification, drawings and abstract.

### BACKGROUND

### 1. Technical Field

The disclosure relates to a shared vehicle management server and a non-transitory storage medium storing a shared vehicle management program.

### 2. Description of Related Art

As an example of a shared vehicle management server, a server is disclosed in Japanese Patent Application Publication No. 2012-215921 (JP 2012-215921 A). In the case where a congestion degree of a parking lot as a destination is higher than a specified value, the server disclosed in this Publication suggests to a user an alternative parking lot, where a travel distance from the destination parking lot is the shortest. In the case where the user uses the suggested parking lot, the user is charged for a fee that is discounted in accordance with an increase in required duration. In this way, use of the alternative parking lot is promoted.

### SUMMARY

By the way, it is normal that travel performance requested for a vehicle differs by a characteristic of a region where the vehicle travels. However, the server disclosed in above Publication allocates the shared vehicle without taking the characteristic of the region into consideration. Thus, there is still room for improvement in convenience of the shared vehicle.

The disclosure provides a shared vehicle management server and a non-transitory storage medium storing a shared vehicle management program capable of improving convenience of a shared vehicle by allocating the shared vehicle in accordance with a characteristic of a region.

A first aspect of the disclosure provides a shared vehicle management server. The shared vehicle management server includes: a use history management section configured to manage, per model of shared vehicles, as use history of at least one parking lot, a use start point, the use start point being a point where a user starts using a shared vehicle among the shared vehicles; a demand calculation section configured to calculate, based on the use history of the at least one parking lot, a demand for the shared vehicles per model of the shared vehicles in each of the at least one parking lot; and a vehicle allocation management section configured to manage allocation of the shared vehicles to each of the at least one parking lot per model of the shared vehicles, based on the demand for the shared vehicles per model of the shared vehicles, and manage, per region including the at least one parking lot, use and return of the shared vehicles parked in the at least one parking lot.

With the above configuration, the allocation of the shared vehicles per model to the parking lot provided in each of the regions is managed on the basis of the use history of the parking lot that is managed per model of the shared vehicles. Thus, the shared vehicles of the model suited for the characteristic of the region are preferentially allocated to the parking lot. Therefore, convenience of the shared vehicles can be improved.

In the first aspect, the use history management section may be configured to store, in a storage unit, a teaching data in which attribute information contributing to use of the shared vehicles is associated with the use history of the shared vehicles, and the demand calculation section may be configured to perform machine learning using the teaching data and predict the demand for the shared vehicles per model of the shared vehicles, based on the attribute information, the attribute information being input when the user makes a reservation for use of the shared vehicle among the shared vehicles.

With the above configuration, the machine learning is performed by using the teaching data, in which the attribute information contributing to the use of the shared vehicles is associated with the use history of the shared vehicles. Thus, the demand for the shared vehicles can be predicted per model.

In the first aspect, the shared vehicle management server may include a revenue model optimizing section configured to generate, by using the demand for the shared vehicles per model of the shared vehicles as input and by referring to a use price per model of the shared vehicles, the use price being stored in the storage unit, a revenue model of a use service of the shared vehicles, and optimize the revenue model while changing the use price per model of the shared vehicles, wherein the vehicle allocation management section may be configured to change, based on the demand for the shared vehicles, the demand corresponding to the revenue model optimized by the revenue model optimizing section, the allocation of the shared vehicles per model in each of the at least one parking lot.

With the above configuration, the allocation of the shared vehicles per model to the parking lot is changed in such a manner as to optimize the revenue of the use service of the shared vehicles. Thus, earning capacity of a business operator at the time of running the use service of the shared vehicles is improved, which can motivate the business operator to start the business.

A second aspect of the disclosure provides a shared vehicle management server. The shared vehicle management server includes: a use history management section configured to manage, per model of shared vehicles, as use history of at least one parking lot, a use start point, the use start point being a point where a user starts using a shared vehicle among the shared vehicles; a demand calculation section configured to calculate, based on the use history of the at least one parking lot, a demand for the shared vehicles per model of the shared vehicles in each of the at least one parking lot; and a revenue model optimizing section configured to generate, by using the demand for the shared vehicles per model of the shared vehicles as input and by referring to a use price per model of the shared vehicles, the use price being stored in a storage unit, a revenue model of a use service of the shared vehicles, and optimize the revenue model while changing the use price per model of the shared vehicles.

A third aspect of the disclosure provides a non-transitory storage medium storing a shared vehicle management program causing a computer to execute: a use history management process to manage, per model of shared vehicles, as use history of at least one parking lot, a use start point, the use start point being a point where a user starts using a shared vehicle among the shared vehicles; a demand calculation process to calculate, based on the use history of the at least one parking lot, a demand for the shared vehicles per model of the shared vehicles in each of the at least one parking lot; and a vehicle allocation management process to manage allocation of the shared vehicles to each of the at least one parking lot per model of the shared vehicles, based on the demand for the shared vehicles per model of the shared vehicles.

With the above configurations, the demand for the shared vehicles per model in the parking lot can be calculated in such a manner as to optimize the revenue of the use service of the shared vehicles.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram of a schematic configuration of a shared vehicle management server according to an embodiment;

FIG. 2 is a graph indicating a correlation between a demand for a shared vehicle and a use price of the shared vehicle;

FIG. 3 is a graph indicating a correlation between a weighting coefficient and rental duration of the shared vehicle;

FIG. 4 is a graph indicating a correlation between the weighting coefficient and rental frequency of the shared vehicle; and

FIG. 5 is a schematic table of an example of contents of data in a vehicle allocation database.

### DETAILED DESCRIPTION OF EMBODIMENTS

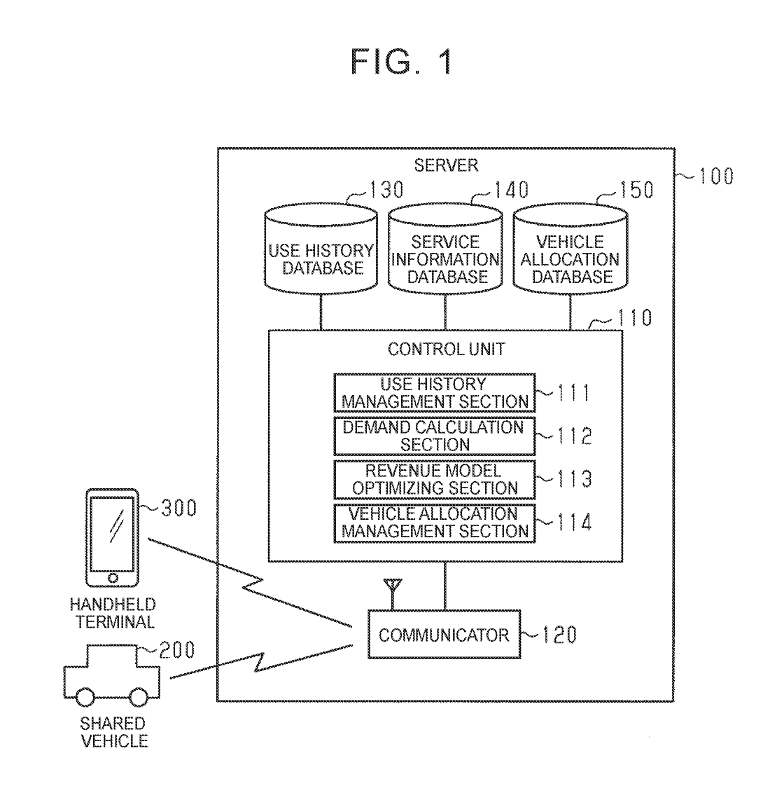

A description will hereinafter be made on a shared vehicle management server according to an embodiment with reference to the drawings. As shown in FIG. 1, the shared vehicle management server according to this embodiment is constructed of a server 100 that manages travel information of plural shared vehicles 200. The server 100 includes a control unit 110, a communicator 120, a use history database 130, a service information database 140, and a vehicle allocation database 150.

When managing allocation of the shared vehicles 200, the control unit 110 functions as a use history management section 111, a demand calculation section 112, a revenue model optimizing section 113, and a vehicle allocation management section 114. When receiving an application for use of the shared vehicle 200 from a handheld terminal 300 via the communicator 120, the use history management section 111 accumulates a use start point of the shared vehicle 200, which is specified in the use application, in the use history database 130 as use history of the shared vehicle 200. The use history management section 111 also accumulates a use price at the time of use of the shared vehicle 200 in the use history database 130 in association with the use history of the shared vehicle 200. The use history management section 111 further stores attribute information at the time when a user uses the shared vehicle 200 in the service information database 140. The attribute information includes a user ID as well as a model, rental duration, rental frequency, and the like of the shared vehicle 200.

On the basis of the use history of the shared vehicle 200 accumulated in the use history database 130, the demand calculation section 112 calculate demands for the shared vehicle 200 per model in one or plural parking lots in each of plural regions. In detail, the demand calculation section 112 calculates the demand for the shared vehicle 200 in each of the parking lots on the basis of a value acquired by accumulating the number of times that the plural users set the respective parking lot as the use start points of the shared vehicle 200. As the frequency of setting the parking lot as the use start points of the shared vehicle 200 by the users is increased, the demand for the shared vehicle 200 in the parking lot is increased.

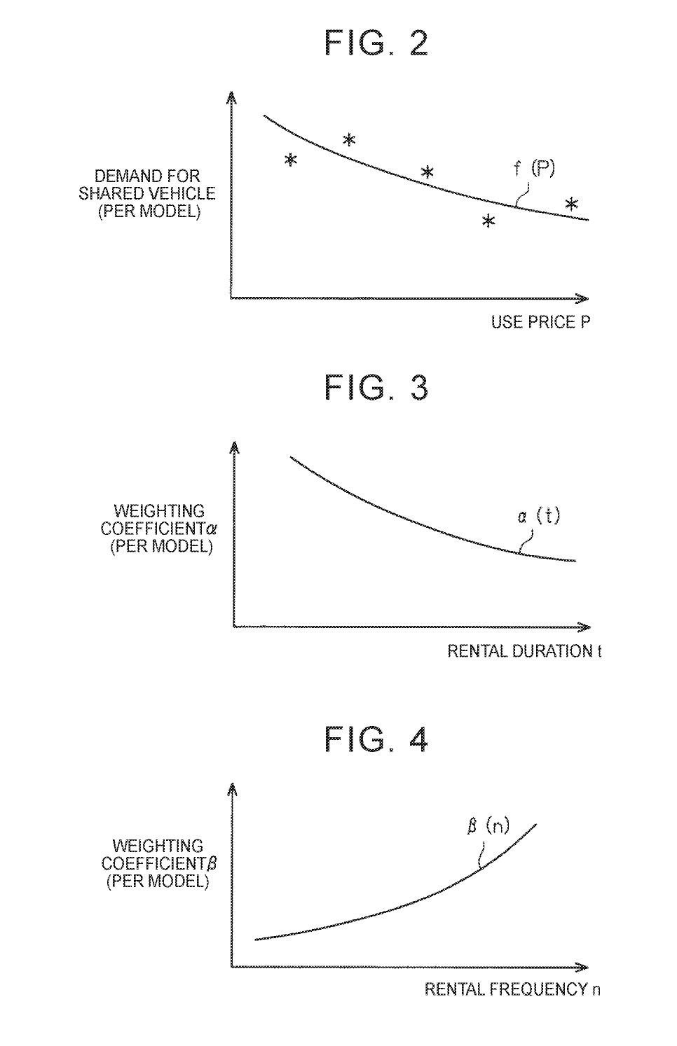

The demand calculation section 112 also calculates a demand predict model that indicates a corresponding relationship between the demand for the shared vehicle 200 per model in each of the parking lots and the use price of the corresponding shared vehicle 200. In detail, as shown in FIG. 2, the demand calculation section 112 applies machine learning to teaching data that indicates the corresponding relationship between the demand for the shared vehicle 200 in each of the parking lots and a use price P of the corresponding shared vehicle 200, so as to calculate a function f(P) indicative of the corresponding relationship between the demand for the shared vehicle 200 and the use price of the shared vehicle 200 as the demand predict model. In this case, the demand calculation section 112 calculates the function f(P), which indicates the corresponding relationship between the demand for the shared vehicle 200 and the use price of the shared vehicle 200, per model of the shared vehicles 200. In general, the function f(P) indicates such a tendency that the demand for the shared vehicle 200 is decreased as the use price of the shared vehicle 200 is increased. In addition, the demand calculation section 112 multiplies the function f(P), which is calculated as described above, by a weighting coefficient α(t) and a weighting coefficient β(n) so as to correct the demand predict model of the shared vehicle 200.

As shown in FIG. 3, the weighting coefficient α(t) is a function indicative of a relationship between the demand for the shared vehicle 200 and rental duration t of the shared vehicle 200, and is calculated per model of the shared vehicles 200. In an example shown in FIG. 3, the weighting coefficient α(t) indicates such a tendency that the demand for the shared vehicle 200 is decreased as the rental duration t of the shared vehicle 200 is extended. This is because it is assumed that the model of the shared vehicle 200 is a compact car and thus the demand for the shared vehicle 200 is increased for short-distance travel.

As shown in FIG. 4, the weighting coefficient β(n) is a function indicative of a relationship between the demand for the shared vehicle 200 and rental frequency n of the shared vehicle 200, and is calculated per model of the shared vehicles 200. In an example shown in FIG. 4, the weighting coefficient β(n) indicates such a tendency that the demand for the shared vehicle 200 is increased as the rental frequency n of the shared vehicle 200 is increased. This is because, when the rental frequency n of the shared vehicle 200 is increased, it is assumed that the user is used to driving the shared vehicle 200 and thus the demand for the shared vehicle 200 is increased.

The revenue model optimizing section 113 inputs the attribute information, which is used at the time when the user makes a reservation for use of the shared vehicle 200, to the demand predict model calculated by the demand calculation section 112, so as to predict the demand for the shared vehicle 200. In the attribute information, the rental duration, the rental frequency, and the like of the shared vehicle 200 are associated with the user ID as a key. Then, the revenue model optimizing section 113 calculates a revenue model of a use service of the shared vehicle 200 by using a predict value of the demand for the shared vehicle 200, which is based on the demand predict model, as the input. In this case, the predict value of the demand for the shared vehicle 200, which is input to the revenue model, is changed in accordance with the use price of the shared vehicle 200. Thus, the revenue model is a model whose output value fluctuates in accordance with the use price of the shared vehicle 200. For this reason, the revenue model optimizing section 113 calculates the output value of the revenue model while changing the use price of the shared vehicle 200 within a predetermined range, so as to optimize (maximize) the output value of the revenue model. As a result, the revenue model optimizing section 113 calculates an optimized value of the demand for the shared vehicle 200 at the time when the output value of the revenue model is optimized.

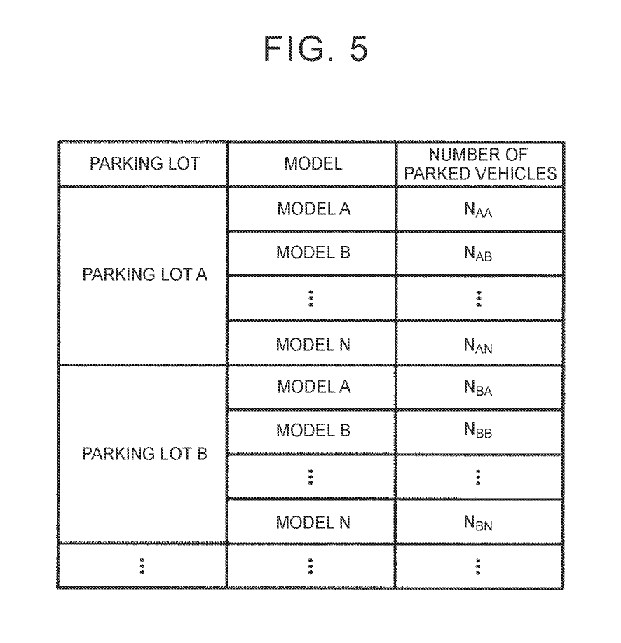

The vehicle allocation management section 114 stores the optimized value of the demand for the shared vehicle 200, which is calculated by the revenue model optimizing section 113, in the vehicle allocation database 150. In this case, as shown in FIG. 5, in the vehicle allocation database 150, the optimized value of the demand for the shared vehicle 200 is managed per model of the shared vehicles 200 as the number of the shared vehicles 200 parked in each of the parking lots. The vehicle allocation management section 114 also receives a detection signal of a Global Positioning System (GPS) mounted on each of the shared vehicles 200 through the communicator 120 and thereby manages position information of each of the shared vehicles 200. Then, referring to the vehicle allocation database 150, the vehicle allocation management section 114 manages allocation of the shared vehicles 200 in each of the parking lots. In this way, the vehicle allocation management section 114 changes the allocation of the shared vehicle 200 per model to each of the parking lots in such a manner as to optimize revenue of the use service of the shared vehicles 200.

As it has been described so far, the following effects can be exerted by the above embodiment.

(1) On the basis of the use history of the parking lot, which is managed per model of the shared vehicles 200, the vehicle allocation management section 114 manages the allocation of the shared vehicle 200 per model in each of the parking lots in each of the regions. In this way, the shared vehicle 200 of the model suited for the characteristic of the region is preferentially allocated to the parking lot, and thus convenience of the shared vehicle 200 can be improved.

(2) The demand calculation section 112 performs the machine learning by using the teaching data, in which the attribute information contributing to the use of the shared vehicle 200 is associated with the use history of the shared vehicle 200. In this way, the demand calculation section 112 can predict the demand for the shared vehicle 200 per model.

(3) The vehicle allocation management section 114 changes the allocation of the shared vehicle 200 per model to each of the parking lots in such a manner as to optimize the revenue of the use service of the shared vehicles 200. Thus, it is possible to increase earning capacity of a business operator who runs the use service of the shared vehicles 200. Such a fact can motivate the business operator to start the business.

Note that the above embodiment can be changed and implemented as in the following modes.

In the above embodiment, the description has been made on the example in which the server predicting the demand for the shared vehicle 200, the server predicting the revenue of the use service of the shared vehicles 200, and the server managing the allocation of the shared vehicles 200 are the same server. However, the servers, each of which has one of the functions, may be provided separately, and information processing may cooperatively be executed among the servers.

In the above embodiment, the vehicle allocation management section 114 changes the allocation of the shared vehicle 200 per model to each of the parking lots in such a manner as to optimize the revenue of the use service of the shared vehicles 200. However, the vehicle allocation management section 114 does not always have to consider the revenue of the use service of the shared vehicles 200 when allocating the shared vehicles 200. For example, the vehicle allocation management section 114 may manage the allocation of the shared vehicles 200 on the basis of the demand for the shared vehicle 200 per model in each of the parking lots.

In the above embodiment, the demand calculation section 112 performs the machine learning using the teaching data, in which the attribute information contributing to the use of each of the shared vehicles 200 is associated with the use history of the respective shared vehicle 200. In this way, the demand calculation section 112 predicts the demand for the shared vehicles 200. However, the demand calculation section 112 does not always have to associate the attribute information to the use history of the shared vehicles 200 when predicting the demand for the shared vehicles 200. For example, the demand calculation section 112 may predict a function indicative of a time change in the demand for the shared vehicles 200 on the basis of time-series data of the use history (the demand) of the shared vehicles 200, and may use the predicted function to predict the demand for the shared vehicles

In the above embodiment, the demand calculation section 112 multiples the function f(P), which indicates the corresponding relationship between the demand for the shared vehicles 200 per model in each of the parking lots and the use price of the respective shared vehicle 200, by the weighting coefficient α(t) related to the use price of each of the shared vehicles 200 and the weighting coefficient β(n) related to the use frequency of the shared vehicle 200. In this way, the demand calculation section 112 calculates the demand predict model of each of the shared vehicles 200. Instead of the above, the demand calculation section 112 may calculate the demand predict model of each of the shared vehicles 200 by applying the machine learning to the teaching data that has the use price, the rental duration, the rental frequency, and the like of the shared vehicles 200 per model as attribute information.

What is claimed is:

1. A shared vehicle management server comprising:
a use history management section configured to manage, per model of shared vehicles, as use history of at least one parking lot, a use start point, the use start point being a point where a user starts using a shared vehicle among the shared vehicles;
a demand calculation section configured to calculate, based on the use history of the at least one parking lot, a demand for the shared vehicles per model of the shared vehicles in each of the at least one parking lot; and
a vehicle allocation management section configured to
manage allocation of the shared vehicles to each of the at least one parking lot per model of the shared vehicles, based on the demand for the shared vehicles per model of the shared vehicles, and
manage, per region including the at least one parking lot, use and return of the shared vehicles parked in the at least one parking lot.

2. The shared vehicle management server according to claim 1, wherein
the use history management section is configured to store, in a storage unit, a teaching data in which attribute information contributing to use of the shared vehicles is associated with the use history of the shared vehicles, and
the demand calculation section is configured to
perform machine learning using the teaching data and
predict the demand for the shared vehicles per model of the shared vehicles, based on the attribute information, the attribute information being input when the user makes a reservation for use of the shared vehicle among the shared vehicles.

3. The shared vehicle management server according to claim 2 further comprising
a revenue model optimizing section configured to
generate, by using the demand for the shared vehicles per model of the shared vehicles as input and by referring to a use price per model of the shared vehicles, the use price being stored in the storage unit, a revenue model of a use service of the shared vehicles, and
optimize the revenue model while changing the use price per model of the shared vehicles, wherein
the vehicle allocation management section is configured to change, based on the demand for the shared vehicles, the demand corresponding to the revenue model optimized by the revenue model optimizing section, the allocation of the shared vehicles per model in each of the at least one parking lot.

4. A shared vehicle management server comprising:
a use history management section configured to manage, per model of shared vehicles, as use history of at least one parking lot, a use start point, the use start point being a point where a user starts using a shared vehicle among the shared vehicles;
a demand calculation section configured to calculate, based on the use history of the at least one parking lot, a demand for the shared vehicles per model of the shared vehicles in each of the at least one parking lot; and
a revenue model optimizing section configured to
generate, by using the demand for the shared vehicles per model of the shared vehicles as input and by referring to a use price per model of the shared vehicles, the use price being stored in a storage unit, a revenue model of a use service of the shared vehicles, and
optimize the revenue model while changing the use price per model of the shared vehicles.

5. A non-transitory storage medium storing a shared vehicle management program causing a computer to execute:
a use history management process to manage, per model of shared vehicles, as use history of at least one parking lot, a use start point, the use start point being a point where a user starts using a shared vehicle among the shared vehicles;
a demand calculation process to calculate, based on the use history of the at least one parking lot, a demand for the shared vehicles per model of the shared vehicles in each of the at least one parking lot; and
a vehicle allocation management process to manage allocation of the shared vehicles to each of the at least one parking lot per model of the shared vehicles, based on the demand for the shared vehicles per model of the shared vehicles.
